(19) United States
(12) Patent Application Publication
(10) Pub. No.: US 2019/0183718 A1
(43) Pub. Date: Jun. 20, 2019

(54) LINK SUPPORT FOR WALKING AID DEVICES

(71) Applicant: Applied Mobility Devices, LLC, Estero, FL (US)

(72) Inventors: William Scott, Estero, FL (US); Joseph Cuiffi, Pittsburgh, PA (US)

(21) Appl. No.: 15/868,967

(22) Filed: Jan. 11, 2018

Related U.S. Application Data
(60) Provisional application No. 62/444,912, filed on Jan. 11, 2017.
(60) Provisional application No. 62/444,921, filed on Jan. 11, 2017.
(60) Provisional application No. 62/444,923, filed on Jan. 11, 2017.

(51) Int. Cl. A61H 3/02

(52) U.S. Cl. CPC A61H 3/0244; A61H 2003/007; A61H 2003/025

(57) ABSTRACT

Mobility aid devices, such as crutches, provide improved ergonomics, comfort and support for the user. The crutches can include one or more linkage devices that provide a mechanism to link the crutches together and provide restrictions on the range of motion, improving confidence and safety of the crutch devices. A first linkage device can be designed to attach to an upper portion of the crutch frame or at the axilla support to be placed along a user's back. A second linkage device can be designed to wrap about a waist area of a user and attach to a central portion of the crutch frame or at the grip region. The first and second linkages may be used singularly or in combination.

### CROSS-REFERENCE TO RELATED APPLICATIONS

This application claims the benefit of priority of U.S. provisional patent application No. 62/444,912, filed Jan. 11, 2017, U.S. provisional patent application No. 62/444,921, filed Jan. 11, 2017 and U.S. provisional patent application No. 62/444,923, filed Jan. 11, 2017, the contents of each of which are herein incorporated by reference.

### BACKGROUND OF THE INVENTION

### 1. Field of the Invention

One or more embodiments of the invention relates generally to mobility aid devices. More particularly, the invention relates to improvements to crutches and canes regarding a link system that improves stability and limits the range of motion of the mobility aids.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

For all the extraordinary technological advances made in medical devices over the past half century, crutches (including axilla and forearm styles), and canes walking sticks, substitute crutches and leg/foot prosthesis, walkers have fallen dangerously behind. The basic design of standard crutches, canes and walkers hasn't changed for decades, going back to when the first medical advice given to new patients was “take it easy and go slow.” Unstable, uncomfortable, inflexible and unattractive at best, their design actually impedes a user's return to max-mobility potential. It also contributes to something most mobility device designers don't think about: the loss of dignity the user feels at having to rely on these archaic devices in the first place.

First, they're uncomfortable and fatiguing. This not only limits the time a patient is able to use them but also puts stress on the hands, wrists, forearms, neck and back, which can lead to upper back ailments and other physical disorders, such as rotator cuff tears.

Second, because they so poorly conform to the body's natural physiology, they're awkward to maneuver and thus inherently unstable. This especially applies to children where the majority of hospitals prescribe walkers instead of crutches to kids under age eleven because of this instability. Adolescents, the elderly, the overweight, the out-of-shape and/or those who have been prescribed painkillers or other medications are also affected—which covers just about all of us. The result is often a loss of balance and an awkward, nasty fall that can reinjure the patient or cause new trauma to the head, wrists, ankles and other areas of the body.

These devices have for years been associated with discomfort and instability. What hasn't been addressed up to now is their basic inflexible, “static” nature. That is, they've been designed to accommodate a patient at his/her initial (and therefore worst) point of pain and discomfort; they aren't designed to “adjust” as the user heals and desires greater mobility. This disadvantage actually retards the recovery of the user who's capable of moving more freely than the device will accommodate.

A user walking with crutches will take a minimum of 2,400 steps, with children taking closer to 3,000. The jarring staccato of each of these steps reverberating wave after wave of pain through though the crutches, further causes discomfort to the entire body however specifically irritates the hands, wrists, elbows, shoulder joints and upper back. These inadequacies no nothing to enhance healing and lead to accelerated fatigue.

Not to be overlooked, these stark, Spartan-like devices, which put users in slumped over, clumsy-looking positions, almost seem purposely designed to make the user feel self-conscious and even stigmatized. Nothing about how they look—nor how they make the tottering user look when trying to stay upright—lends dignity to the patient.

Over recent years, however, medical professionals have learned that the key to rapid recovery from surgery, injury or any incident impacting mobility is to get patients up and walking as naturally as their pain will allow, as quickly as possible. Put it all together and medical professionals who must prescribe the use of these particular mobility aids actually find themselves unintentionally violating their sacred oath “to do no harm.”

In view of the foregoing, there is a need for an improved mobility aid device that addresses various design flaws found in conventional mobility aids.

### SUMMARY OF THE INVENTION

Embodiments of the present invention provide a tether for a crutch mobility aid device comprising a linkage that connects a left crutch and a right crutch near an upper portion thereof, the strap operable to wrap around a back of a user during use.

In some embodiments, the linkage is adjustable in length from, for example, about 4 inches to about 25 inches.

In some embodiments, the linkage is removably attached to the left crutch and the right crutch.

In some embodiments, the tether includes a disconnect located along a length of the linkage. The disconnect may include a first disconnect located adjacent the left crutch, a second disconnect located adjacent the right crutch and a central region removable from the first disconnect and the second disconnect.

In some embodiments, a forward range of crutch motion of can be limited to about 5 degrees to about 45 degrees from vertical.

Embodiments of the present invention further provide a tether system for a crutch mobility aid device comprising an adjustable length linkage that connects a left crutch and a right crutch near an upper portion thereof, the linkage operable to wrap around a back of a user during use; and a waistband strap having a loop, operable to be positioned about a user, and connectors for connecting the loop to the left crutch and the right crutch.

In some embodiments, the strap and the waistband strap may be used together or separately.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a side view of a set of crutches having a linkage interconnecting the crutches according to an exemplary embodiment of the present invention;

FIG. 2 is a close-up view of the linkage of FIG. 1;

FIG. 3A is a side view of a user using the set of crutches of FIG. 1;

FIG. 3B is a side view of a user using the set of crutches of FIG. 1, illustrating a limited forward range of motion;

FIG. 4 is a front view of a user using the set of crutches of FIG. 1, illustrating a limited range of outward motion;

FIGS. 5A and 5B are a perspective view of the linkage, length adjustment mechanisms, and connection mechanism according to exemplary embodiments of the present invention;

FIG. 6A is a side view of a set of crutches having a first linkage interconnection an upper portion of the crutches and a waistband linkage, according to an exemplary embodiment of the present invention;

FIG. 6B is a perspective view of the waistband linkage, length adjustment mechanisms, and connection mechanisms according to exemplary embodiments of the present invention; and

FIG. 7 is a perspective view of a user wearing a backpack that forms a portion of the linkage between the crutches, according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide mobility aid devices, such as crutches, that provide improved ergonomics, comfort and support for the user. The crutches can include one or more linkage devices that provide a mechanism to link the crutches together and provide restrictions on the range of motion, improving confidence and safety of the crutch devices. A first linkage device can be designed to attach to an upper portion of the crutch frame or at the axilla support to be placed along a user's back. A second linkage device can be designed to wrap about a waist area of a user and attach to a central portion of the crutch frame or at the grip region. The first and second linkages may be used singularly or in combination.

Current basic crutches suffer from a lack of stability and often “slip-out” from under the armpit area. Furthermore, the crutches have an unlimited range of motion (out to the sides, swinging front and rear), which is not necessary for walking movements and cause a sense of instability. Cuff-style crutches are held to the arm in a more secure way, but they still suffer from an unlimited range of motion. The tether devices according to embodiments of the present invention provide a mechanism to link the crutches together and provide restrictions on the range of motion, improving confidence and safety of the crutch devices.

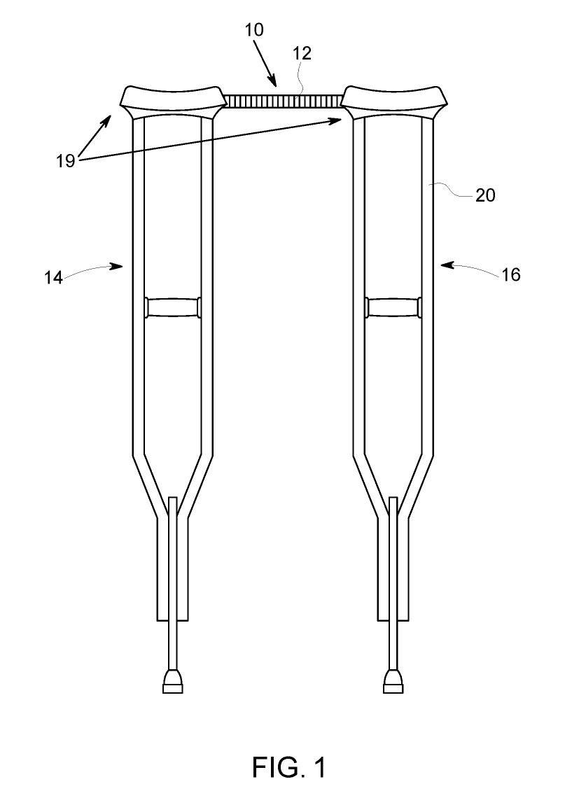

An exemplary embodiment of a tether device 10 according to an embodiment of the present invention is shown in FIG. 1. The tether device 10 includes a strap or tether 12 that connects the two crutches 14, 16 near a top portion 18 of the crutches 14, 16. The tether 12 may be connected to a frame portion 20 or other parts of the crutch assembly including the axilla support 22.

Although the linkage shown as a tether device 10 in FIG. 1, embodiments of the present invention include linkages that are made from both soft, flexible materials and hard materials. The linkage may be fabricated using cloth and fabric straps, tethers or ropes or hard materials such as metals, plastics, rubber and combinations thereof. The hard materials may or may not be flexible depending on design. The linkage device according to embodiments of the present invention can be made entirely of hard parts and in some cases, that may be a preferred method for durability or restrictions on movement. One simple embodiment of the present invention is to have the rear portions of the axilla connect together, proving a defined distance between the rear poles, serving as a linkage. The connection and adjustment methods described herein apply to all types of linkages, although the tether style is used as an exemplary embodiment below.

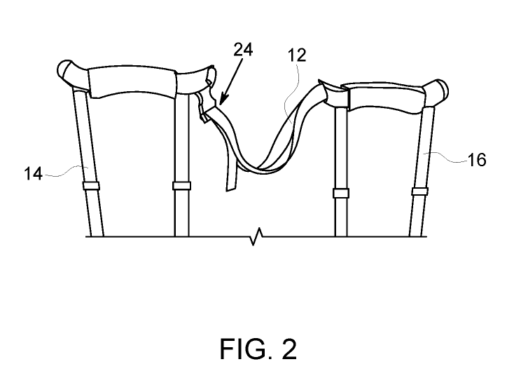

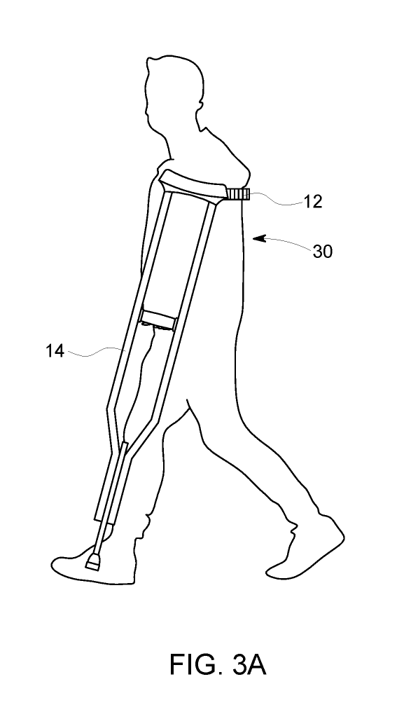

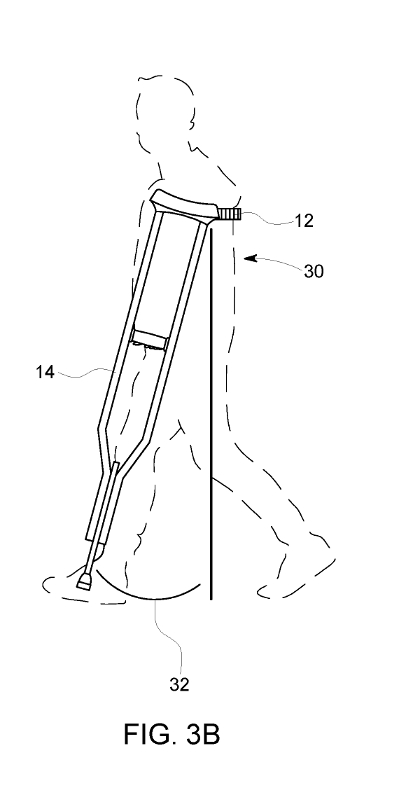

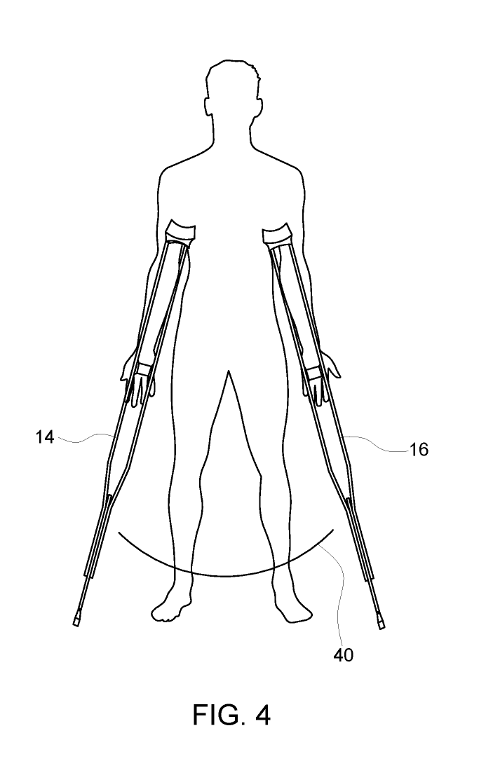

Referring to FIGS. 2, 3A and 3B, the tether 12, which links the crutches 14, 16 together, may wrap around the user's back 30 when using the crutches as shown in FIG. 3A. The tether 12 can be adjusted (tightened or shortened) to limit the range of motion of the crutches 14, 16. FIG. 2 shows a simple ladder lock buckle adjustment mechanism 24 that allows for the tether 12 to be shortened or lengthened. Shortening the tether 12 will cause the forward motion of the crutches 14, 16 to be limited, as shown in FIG. 3B. As the crutches 14, 16 are swung forward, the tether 12 tightens against the user's back 30. This serves three purposes: 1) it provides guidance for recovery by severely limiting range of motion (step size) during the early recovery phase, then allowing larger steps as recovery proceeds, 2) it prevents the crutch from slipping out of the axilla area or the foot slipping forward on the floor, and 3) it provides a strong sense of confidence and control with the crutches, as noted by user testing. As shown in FIG. 4, the tether 12 also limits outward motion 40, which contributes to the purposes 2) and 3) stated above.

The range of tether adjustment necessary for most users (children through adults) is typically between about 4 inches to about 25 inches. The adjustment required to limit crutch motion varies by user body dimensions, but it is relatively straightforward to adjust the length of the tether 12 to a desired range of motion restriction. The adjustment fundamentally provides a trade-off between stability and increased range of motion (step size). Practically, the forward crutch angle 32, shown in FIG. 3, can be limited to a range of about 5 degrees to about 45 degrees from vertical using the tether 12.

User testing of the tether 12 of the present invention has shown that users experience a very significant increase in confidence and stability over standard crutches. Users report that the crutches 14, 16, with the tether 12, actually feel “linked” as one unit. This not only provides increased dignity for the user, but also provides a reduced chance of falls.

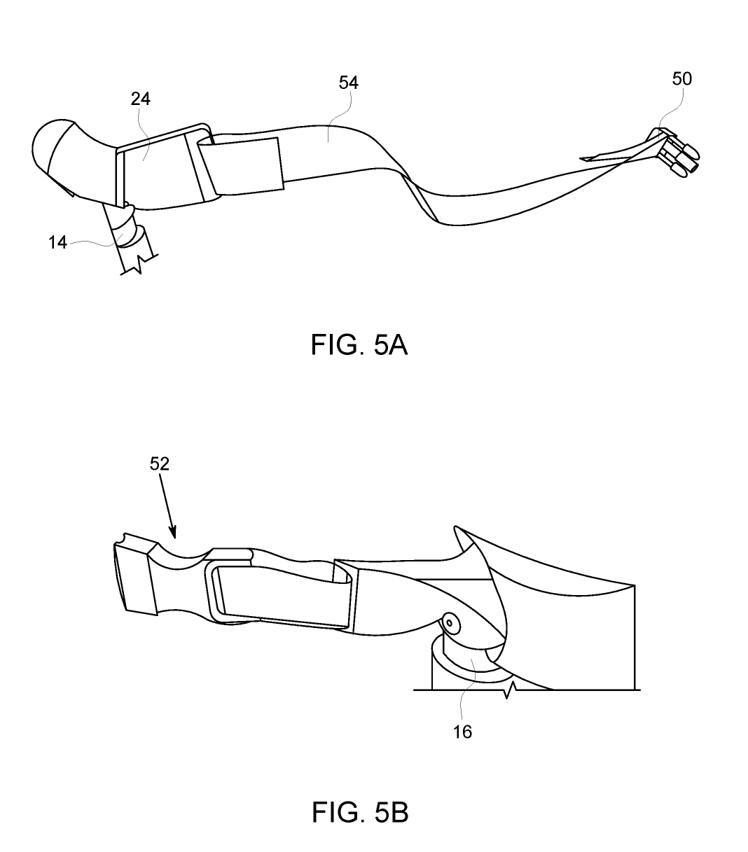

As shown in FIGS. 5A and 5B, the tether 12, according to embodiments of the present invention, can be modified to easily disconnect. This gives the user the option to use the crutches with or without the tether 12. One clip can be used, such as a male clip 50 and a female release buckle 52, as shown, or two clip male clips 50 can be used to leave small end pieces attached to the crutches, with an intermediate, adjustable tether having the female release buckles 52 on each end thereof, instead of a longer tether piece 54 as shown in FIG. 5A. Of course, various types of disconnects, adjustment mechanisms, and the like, are contemplated within the scope of the present invention.

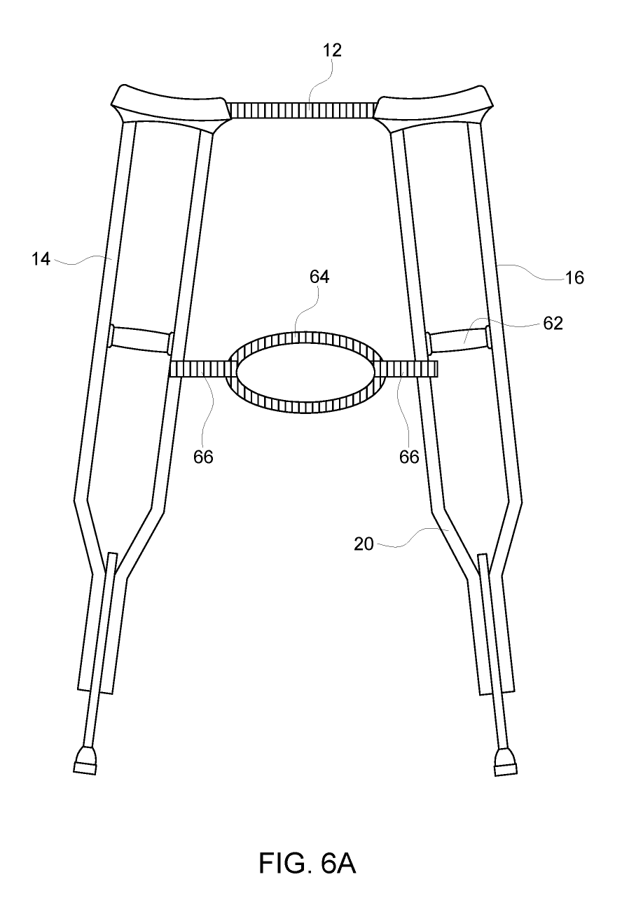

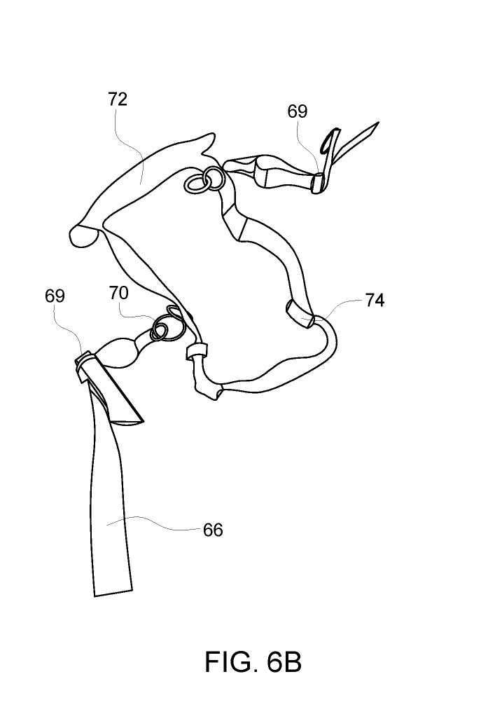

Referring now to FIGS. 6A and 6B, a further embodiment of the present invention includes an additional lower tether 60. The lower tether 60, which may be used in addition to the upper tether 12, can wrap around the user's waist via an adjustable waistband portion 64. The lower tether 60 can further limits the range of motion and creates an extremely stabile feeling when using the crutches 14, 16. The combination of the two tethers 12, 60 causes the crutches 14, 16 to act like an extension of one's body, reducing fatigue and greatly improving confidence.

The lower tether 60 can also be modified with various adjustment and release mechanisms for fitment and ease of attachment. For example, side portions 66 of the lower tether 60 can attach to the frame 20 of a grip 62 of the crutches 14, 16 via various mechanisms as may be known in the art. The side portions 66 may include a length adjustment mechanism 68 and more include a removable attachment mechanism 70 for attaching to the waistband portion 64. In some embodiments, the waistband portion 64 may include padding 72 and may further include adjustment mechanisms 74 as may be known in the art.

The linkages may be made of various materials as may be known in the art, such as flexible fabric, or the like. The linkages may be made of a flexible elastic or inelastic material, depending on the particular or user preference. More generally, the linkage may be fabricated using cloth and fabric straps, tethers or ropes or hard materials such as metals or plastics and combinations thereof.

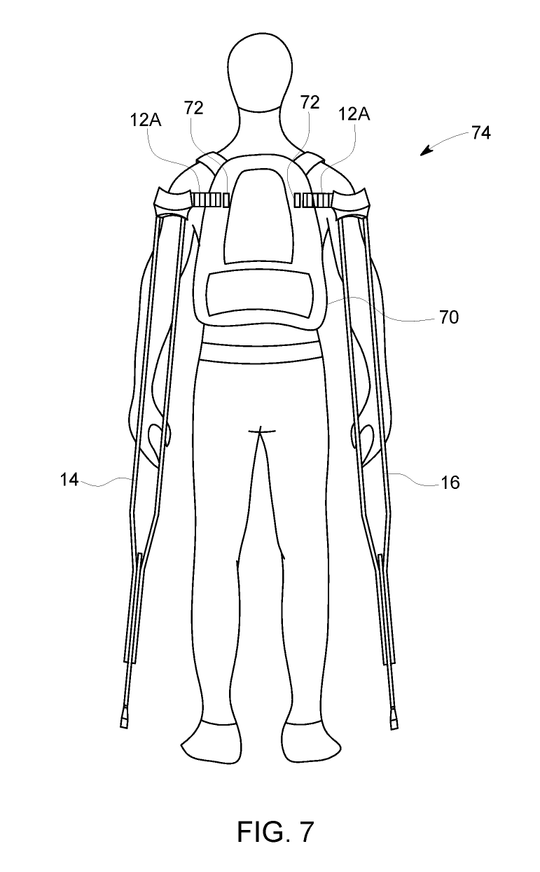

While the Figures show a single linkage to join the upper portion of the crutches, in some embodiments, the linkage could be a plurality of linkages. For example, the linkage could be a plurality of straps or a combination of flexible and inflexible materials. In some embodiments, the linkage could include other items. For example, the linkages may removably attach to any article worn by the user 74, such as a backpack 70, as shown in FIG. 7, or an article of clothing, for example. The backpack 70 can include a connector 72 that the linkages 12A from the crutches 14, 16 may connect. Optionally, the linkages 12A may be configured to connect to a conventional backpack without such connectors 72. Similarly, the waistband linkage may attach to an article of clothing worn by a user, such as their belt, pants waistband, or the like.

Regardless of mechanism, the linkages as described herein form an interconnection between the crutches.

The linkages, according to embodiments of the present invention can be used on most varieties of crutches, both axilla and cuff styles, to improve stability. Many crutches can be retrofit, allowing for a linkage to be used on many styles of crutches. The linkage can also be integrated into the design of a crutch, as shown in FIG. 2. In some embodiments, the linkage 12 may connect with a slot formed in the axilla support 22, as described in commonly-owned, concurrently filed U.S. patent application Ser. No. ______, entitled “Ergonomic Grip and Axilla for Walking Aid Devices”, the contents of which are herein incorporated by reference.

Some examples of mobility aid devices that may be used with the linkage of the present invention are described in commonly-owned, concurrently filed U.S. patent application Ser. No. ______, entitled “Ergonomic Grip and Axilla for Walking Aid Devices”, No. ______, entitled “Dynamic Foot Support for Walking Aid Devices”, and No. ______, entitled “Frame Configurations for Mobility Aid Devices”, the contents of each of which are herein incorporated by reference in their entirety.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A device for a crutch mobility aid device comprising:
a linkage that connects left crutch and a right crutch near a rear axilla portion thereof, the linkage operable to wrap around a back of a user during use.

2. The device of claim 1, wherein the linkage is adjustable in length.

3. The device of claim 2, wherein the linkage is adjustable in length from about 4 inches to about 25 inches.

4. The device of claim 1, wherein the linkage is removably attached to the left crutch and the right crutch.

5. The device of claim 1, further comprising a disconnect located along a length of the linkage.

6. The device of claim 1, further comprising:
a first disconnect located adjacent the left crutch;
a second disconnect located adjacent the right crutch; and
a central region removable from the first disconnect and the second disconnect.

7. The device of claim 1, wherein a forward range of crutch motion of can be limited to about 5 degrees to about 45 degrees from vertical.

8. The device of claim 1, further comprising a waistband having one or more loops, operable to be positioned about a user, and connectors for connecting the loops to the left crutch and the right crutch.

9. The device of claim 8, wherein the waistband is adjustable in length.

10. The device of claim 8, wherein the connectors are adjustable in length.

11. The device of claim 8, wherein the connectors are removably attached to the waistband.

12. The device of claim 1, wherein the mobility aid device is one of an underarm crutch and a forearm crutch.

13. The device of claim 1, wherein the linkage includes at least one of tethers, straps, and flexible materials.

14. The device of claim 1, wherein the linkage includes at least one of plastics, metals and hard materials.

15. The device of claim 1, wherein the linkage includes an article worn by the user.

16. A system for a crutch mobility aid device comprising:
an adjustable length linkage that connects a left crutch and a right crutch near an a rear axilla portion thereof, the linkage operable to wrap around a back of a user during use;
a waistband having one or more loops, operable to be positioned about a user, and
connectors for connecting the loops to the left crutch and the right crutch.

17. The system of claim 16, wherein a forward range of crutch motion of can be limited to about 5 degrees to about 45 degrees from vertical.

18. The system of claim 16, wherein the strap and the waistband strap are removable attached to the left crutch and the right crutch.

19. The system of claim 16, wherein the linkage includes at least one of tethers, straps, and flexible materials.

20. The device of claim 16, the linkage includes at least one of plastics, metals and hard materials.

21. The device of claim 16, wherein the linkage includes an article worn by the user.
